(19) United States
(12) Patent Application Publication
(10) Pub. No.: US 2005/0105533 A1
(43) Pub. Date: May 19, 2005

(54) Video stream server switching

(76) Inventors: Gary L. Malolepsy, Yorba Linda, CA (US); Jim V. Miles, Irvine, CA (US)

Correspondence Address: STETINA BRUNDA GARRED & BRUCKER, 75 ENTERPRISE, SUITE 250, ALISO VIEJO, CA, 92656, US

(21) Appl. No.: 10/931,852

(22) Filed: Sep. 1, 2004

Related U.S. Application Data
(60) Provisional application No. 60/499,583, filed on Sep. 2, 2003.

(51) Int. Cl. H04L 12/28; H04L 12/56; G06F 15/173; G06F 15/177; H04N 7/173

(52) U.S. Cl. 370/395.41; 725/95; 709/220; 709/221; 709/222; 370/395.21; 370/395.4

(57) ABSTRACT

A method is provided for switching video stream servers in a video streaming system adapted to transmit video over the Internet comprising, creating and initializing a plurality of supporting sockets for transmitting video data over the Internet; creating a socket pool comprising a plurality of initialized back-up sockets; reading at least one video piece from at least one of the plurality of supporting sockets; determining whether the time period required for reading the at least one video piece is greater than a predetermined period of time; and switching “bad” supporting sockets, for which the time period for reading at least one video piece was greater than the predetermined period of time, with “good” back-up sockets from the socket pool.

### CROSS-REFERENCE TO RELATED APPLICATIONS

The present application claims priority to Provisional Application No. 60/499,583 to Malolepsy et al., filed on Sep. 2, 2003, the disclosure of which is expressly incorporated by reference herein in its entirety.

### STATEMENT RE: FEDERALLY SPONSORED RESEARCH/DEVELOPMENT

Not Applicable

### BACKGROUND OF THE INVENTION

The present invention relates to methods for switching video stream servers in video streaming systems. Specifically, the present invention relates to a video streaming system which employs a distributed architecture of a plurality of video servers to stream video over multiple Internet connections. The present invention includes methods of switching a video stream between such servers to achieve a reliable video stream signal despite disruptions in operations of the servers or connections.

Streaming video commonly refers to video that can be played live from the Internet. Instead of having to wait until the download is complete to play the video, streaming video can be played real-time while it is being sent to the user's computer. Typically, before the video file is posted on the Internet, it is first compressed and encoded in a special codec (coder/decoder) which is an algorithm that compresses the video to a small size. This algorithm is required because without it, the video file is typically so large that it takes an enormous amount of time to send it across the Internet. The server sends the file in the form of packets across the Internet using the Internet Protocol (IP). Video streaming typically does not use the normal Internet TCP (Transport Control Protocol); rather, video streaming uses UDP (User Datagram Protocol). Unlike TCP, UDP does not constantly check to see whether data has been sent, so it results in fewer interruptions in the file transfer. The video packets are sent to a buffer (memory) in the user's computer. The transmitting server can tell by how fast the buffer fills up by determining the speed of the user's connection. At higher speeds, the server will send more video data, resulting in a smoother, more lifelike video. At lower speeds, the server sends less data, which causes the video quality to suffer. When the buffer fills up, this may take only a few seconds, a video player can then be launched on the user's computer. As the video is being continuously played, video packets are still being delivered to the buffer. Data from the buffer is continually sent to the player so that the entire video can be watched. When all the video data has been sent, the video will stop. It is further noted that typically, the video file does not stay on the user's system; each section of the file is discarded after it is played. A player can be launched in the users' computer without the need for plug-ins commonly required by other streaming applications. This approach is more efficient and less problematic than existing applications.

A significant drawback to utilizing the Internet as the network means for transmitting video streaming data is the limited bandwidth a single Internet connection or “pipe” provides. As shown in FIG. 1, the minimal hardware necessary for a streaming video system is one video server 2 connected to an Internet connection or “pipe” 6 which is then connected to at least one user's system 4. The video server 2 needs to have an Internet pipe 6 with sufficient bandwidth for the desired streaming bit rate multiplied by the simultaneous number of videos to be viewed at once. In order to get the proper transmission speed of data from the video server 2 to the user's system 4, the data must go through the Internet pipe 6, but typically, a single Internet pipe 6 has too little bandwidth.

To overcome the bandwidth limitations of a single Internet pipe 6, video streaming service providers have begun to use multiple Internet pipes 6 as is shown in FIG. 2. By using multiple Internet pipes 6 simultaneously in parallel, the bandwidth through the Internet can be dramatically increased to be more equally matched to the bandwidth of the video server 2 and the user's system 4. Instead of just one Internet connection, several are made in parallel to effectively increase the transfer rate of the video data.

The technique that allows this to work over the Internet is called “stripping”. Stripping breaks the video data into pieces of equal size at the video server 2 and sends multiple pieces over the Internet to the user's system 4 at the same time (parallel transfers). Therefore, network stripping utilizes not just one Internet connection or pipe 6 to transfer data but several Internet pipes 6 in parallel.

The aforementioned video streaming technique is currently used but has at least two drawbacks: (1) If a server fails, video data is lost; (2) If an Internet connection becomes “slow” or “noisy”, video data is delayed or lost. Both of these problems are considered serious transmission anomalies in regard to video transmission quality. For instance, the video may breakup, be distorted, quit, hang up or freeze up.

One solution to overcome the aforementioned problems is to design video streaming systems having a distributed architecture. With distributed network architecture, several video servers are typically used for redundancy purposes. The plurality of servers may be located at different sites to prevent loss of the video stream during power outages and other failures. Such distributed network architecture allows for increased routing efficiency of the video data over multiple connections over the Internet. However, a drawback to the aforementioned system is that often the video stream is still interrupted during the switch or changeover from a failing server to a functioning server.

Therefore, it would be beneficial to provide a method for expediently switching video servers in video streaming systems which use multiple video servers (a distributed architecture) to stream video over multiple Internet connections (sockets). In particular, it would be beneficial to provide an efficient and effective method, process, system and/or computer code for switching between a plurality of video servers such that quality of the video streaming is ensured to be reliable and of an acceptable quality to the end user.

### BRIEF SUMMARY OF THE INVENTION

In addition to the advantages inherent in the design of the disclosed invention, the present invention overcomes and solves problems commonly encountered with video streaming systems having a plurality of servers configured in a distributed architecture and adapted to stream video over multiple Internet connections (sockets).

According to a first exemplary embodiment of the present invention, a method is provided for switching video stream servers in a video streaming system adapted to transmit video over the Internet comprising; creating and initializing a plurality of supporting sockets for transmitting video data over the Internet; creating a socket pool comprising a plurality of initialized back-up sockets; reading at least one video piece from at least one of the plurality of supporting sockets; determining whether the time period required for reading the at least one video piece is greater than a predetermined period of time; and switching problematic supporting sockets, for which the time period for reading the at least one video piece was greater than the predetermined period of time, with nominally performing back-up sockets from the socket pool.

According to an aspect of the present invention, creating and initializing the plurality of supporting sockets includes determining a number of supporting sockets required to effectively transmit video data for a desired application. According to another aspect of the present invention, the number of back-up sockets to be created is determined by multiplying the determined number of supporting sockets by a predetermined factor.

According to yet another aspect of the present invention, the amount of time required for reading at least one video piece is determined by reading a timer at a start time before each video piece is read; reading a timer at an end time after each video piece has been read; and calculating the difference between the start and end time.

According to other aspects of the present invention, the switching further comprises determining a read status for each video piece to verify that the entire video piece was read. Also, according to another aspect of the present invention, switching further comprises determining whether the switching was due in a data header or after the header, and sending such result to a log server for debugging. According to another aspect of the present invention, switching further comprises checking the socket pool to determine if an initialized back-up socket is available before switching a problematic supporting socket with a nominal performing back-up socket. And, according to another aspect of the present invention, switching further comprises parsing a problematic server Uniform Resource Locator (URL) from a data server request and comparing the parsed URL to a list of nominally performing servers that can be switched thereto.

In another aspect of the present invention, switching further comprises copying a nominally performing server URL over the problematic server URL in a data server request such that a nominally performing back-up socket is copied over a problematic supporting socket. The present invention may also include using the data server request to make a new connection to the nominally performing server. Furthermore, switching further comprises sending a log message for debugging and includes resuming reading of a video data piece starting at a current piece count.

According to another exemplary embodiment of the present invention, a computer readable medium is provided for storing a computer program for switching video stream servers in a video streaming system adapted to transmit video over the Internet comprising a source code segment for socket generation and initialization that creates and initializes a plurality of supporting sockets for transmitting video data over the Internet; creates a socket pool comprising of a plurality of initialized back-up sockets; a source code segment for timing of data transfer that reads at least one video piece from at least one of the plurality of supporting sockets; determining whether the time period required for reading at least one video piece is greater than a predetermined period of time; and a source code segment for switching servers that switches problematic supporting sockets, for which the time period for reading the at least one video piece was greater than the predetermined period of time, with nominally performing back-up sockets from the socket pool.

According to an aspect of the present invention, the source code segment for socket generation and initialization further determines a number of supporting sockets required to effectively transmit video data for a desired application. According to another aspect of the present invention, the source segment for socket generation and initialization determines a number of back-up sockets to be created by multiplying the number of supporting sockets by a predetermined factor.

According to yet a further aspect of the present invention, the source code segment for timing of data transfer determines the amount of time required for reading the at least one video piece by reading a timer at a start time before each video piece is read; reading a timer at an end time after each video piece has been read; and calculating the difference between the start and end.

According to another aspect of the present invention, the source code segment for the timing of data transfer further determines a read status for each video piece to verify that the entire video piece was read. According to yet another aspect of the present invention, the source code segment for switching servers determines whether the switching was due in a data header or after the header, and sends such result to a log server for debugging.

According to yet another aspect of the present invention, the source code segment for switching servers checks the socket pool to determine if an initialized back-up is available before switching supporting sockets with a back-up socket. According to another aspect of the present invention, the source code segment for switching servers further parses a problematic server URL from a data server request and compares the parsed URL to a list of nominally performing servers that can be switched thereto. A further aspect of the present invention includes the source code segment for switching servers further copies a new server URL over the problematic server URL in a data server request such that a nominally performing back-up socket is copied over a problematic supporting socket.

According to yet another aspect of the present invention, the source code segment for switching servers further uses the data server request to make a new connection to a nominally performing server. According to other aspects of the present invention, the source code segment for switching servers further sends a log message for debugging. Furthermore, the source code segment for switching servers resumes reading a video data piece starting at a current piece count.

According to another exemplary embodiment of the present invention, a video streaming system is provided which is configured in a distributed network architecture interfaced with the Internet. The system may comprise a plurality of video servers, at least one user system, a logger server, system monitor, and a website server. The video streaming system further comprises a computer readable medium storing a computer program for switching video stream servers in a video streaming system for transmitting video over the Internet comprising a source code segment for socket generation and initialization that creates and initializes a plurality of supporting sockets for transmitting video data over the Internet; creates a socket pool comprising a plurality of initialized back-up sockets; a source code segment for timing of data transfer that reads at least one video piece from at least one of the plurality of supporting sockets; determines whether the time period required for reading the at least one video piece is greater than a predetermined period of time; and a source code segment for switching servers that switches problematic supporting sockets, for which the time period for reading at least one video piece was greater than the predetermined period of time, with nominally performing back-up sockets from the socket pool.

Other exemplary embodiments and advantages of the present invention may be ascertained by reviewing the present disclosure and the accompanying drawings.

### BRIEF DESCRIPTION OF THE DRAWINGS

The present invention is further described in the detailed description that follows, by reference to the noted drawings by way of non-limiting examples of preferred embodiments of the present invention, in which like reference numerals represent similar parts throughout several views of the drawings, and in which:

FIG. 1 depicts relative bandwidth of a server and user compared to the bandwidth of an Internet pipe;

FIG. 2 depicts relative bandwidth of a server and user compared to the bandwidth of a plurality Internet pipes used simultaneously;

FIG. 3 depicts an exemplary streaming video system, according to an aspect of the present invention;

FIG. 4 is a flow chart depicting an exemplary Socket Generation and Initialization sequence, according to an aspect of the present invention;

FIG. 5 is a flow chart depicting an exemplary Timing and Data Transfer sequence, according to an aspect of the present invention; and

FIG. 6 is a flow chart depicting an exemplary Switching Routine, according to an aspect of the present invention.

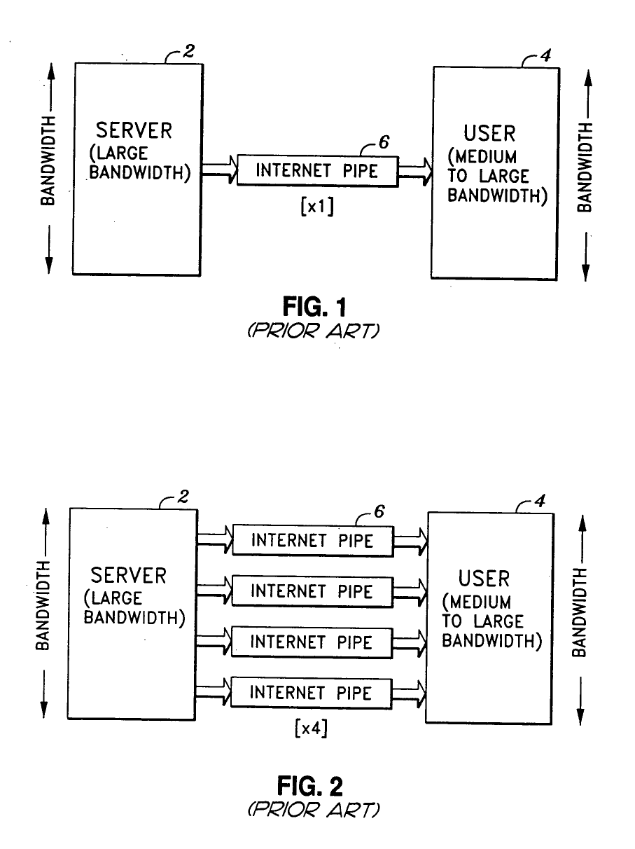

### DETAILED DESCRIPTION OF THE INVENTION

The particulars shown herein are by way of example and for purposes of illustrative discussion of the embodiments of the present invention only and are presented for the cause of providing what is believed to be the most useful and readily understood description of the principles and conceptual aspects of the present invention. In this regard, no attempt is made to show structural details of the present invention in more detail than is necessary for the fundamental understanding of the present invention. The description taken with the drawings makes it apparent to those skilled in the art how numerous forms of the present invention may be embodied in practice.

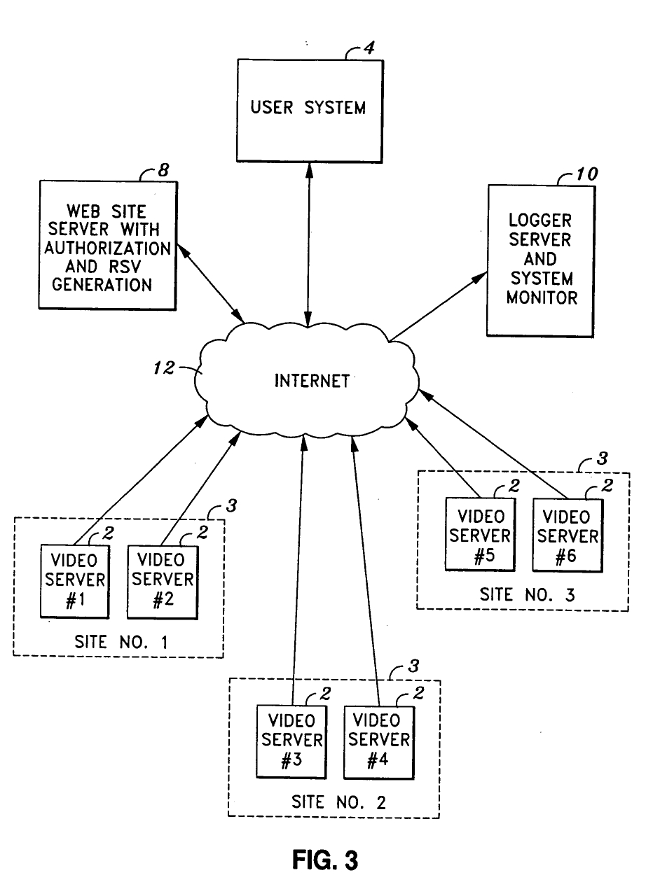

FIG. 3 depicts an exemplary streaming video system, according to an aspect of the present invention. A plurality of video servers 2 (video servers no. 1 through 6) are linked to the Internet 12 in a distributed architecture. According to the present invention, the plurality of video servers 2 may be grouped together at various sites (i.e., sites no. 1 through 3). The streaming video system may also include a web site server with authorization, RSV generation 8 logger server and system monitor 10 linked to the Internet 12. Additionally, the streaming system may include a plurality of user systems 4 (only one shown for illustration purposes on FIG. 3).

The present invention provides a method and process for detecting a problem condition and providing a “switch” which expediently switches from a problematic (or “bad”) connection to a new acceptable and/or nominally performing (or “good”) connection in a video streaming system. The above process provides the ability to transfer and maintain higher bit rates of video stream with greater reliability, security and quality than previous systems. Such aforementioned switch may be integrated with a video streaming system which uses a distributed server architecture and multiple Internet connections or pipes simultaneously. To be successful, the switching must occur in a small enough time increment to allow for video data from the new connection to arrive before the video player buffer runs out. The video system has some buffering to allow for variation in Internet transfer times and the capability of a user's system (which may have a fast or slow computer, fast or slow Internet connection, etc.). The buffer preferably holds about 30 seconds of video data. Thus, the present invention entails a switching technique that is able to detect a problematic (or “bad”) connection, make a new connection with another server and receive data within the 30 second increment allowed by the buffer.

Each TCP segment contains the source and destination port number to identify the sending and receiving application. These two values, along with the source and destination IP addresses in the IP header, uniquely identify each connection. The combination of an IP address and a port number for purposes of this application will be referred to as a socket. It is the socket pair (comprising of the client IP address, client port number, server IP address, and server port number) that specifies the two end points that uniquely identifies each TCP connection.

Each Internet connection preferably utilizes a TCP/IP socket to transfer data. If a connection has a problem, the operating system will attempt to re-transmit the data. Each successive retry may have a delay about twice as long as the prior retry. This can cause delays of a few minutes if the Internet connection is problematic (or “bad”). It has been found that a 4096 byte piece transfer time of less than one second is considered acceptable. If a transfer takes longer than one second, then it is considered problematic (or “bad”) and should be switched. This has the added advantage of keeping all the connections with good transfer times even if a connection had transfer times of over one second but still provided enough video data to play without a problem.

Implementing a switch requires that the problematic (or “bad”) socket is stopped and a new acceptable nominally performing (or “good”) socket is started using a new acceptable nominally performing (or “good”) video server IP address and that the nominally performing (or “good”) video server continues at the place in the video where the problematic or “bad” server terminated. Creating and initializing a new socket requires several seconds which creates latency concerns. To overcome the latency issue, the present invention provides a “socket pool”. In particular, when a video stream is started, more sockets than are required are initially created and initialized. They are not used but are kept in a “socket pool”. If a switch is required, then one of these sockets in the “socket pool” is used. Thus eliminating the latency affiliated with the socket creation/initialization time.

Since the video is broken into pieces of equal length, these pieces become the “address” of where a switch has occurred. Each video piece is counted as it is received. When a switch takes place, the next switch number is sent to the new acceptable nominally performing (or “good”) video server as the starting place to begin sending data. Thus, the data is received without any loss. This design utilizing the “socket pool” along with a one second transfer timing period (or any other timing period deemed acceptable) and the video piece addressing achieves switches in under a second with no interruption to the video streaming or any noticeable loss of video data in the buffers.

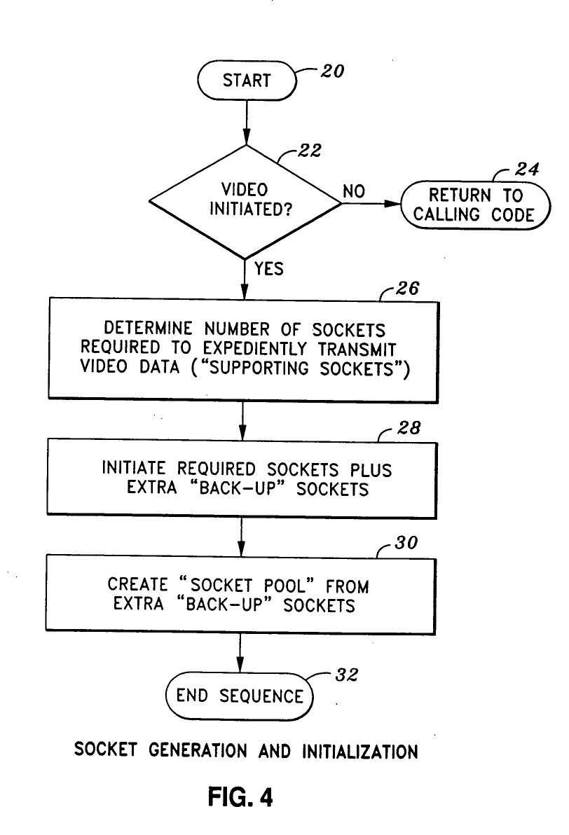

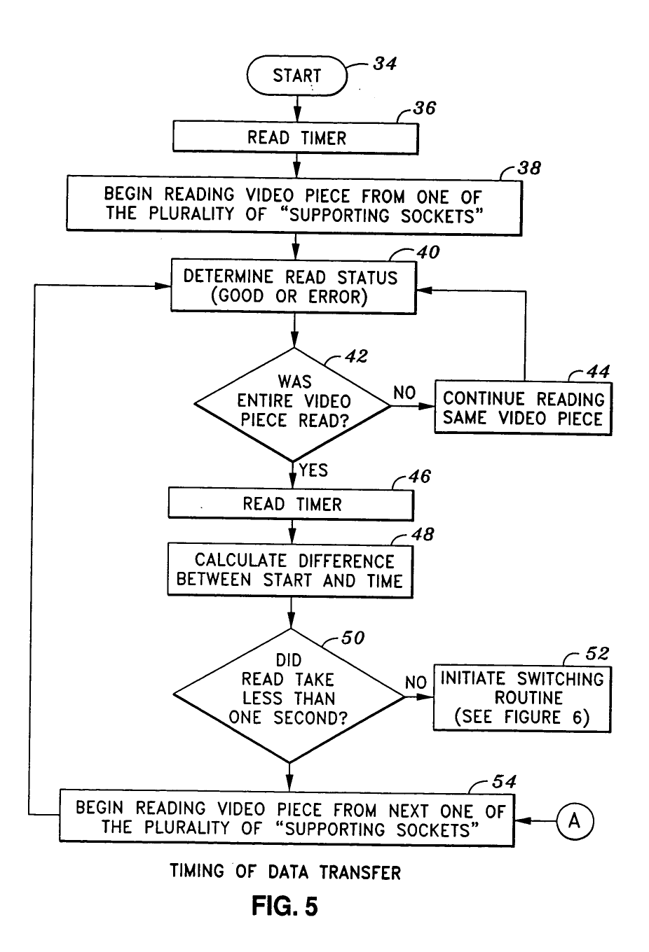

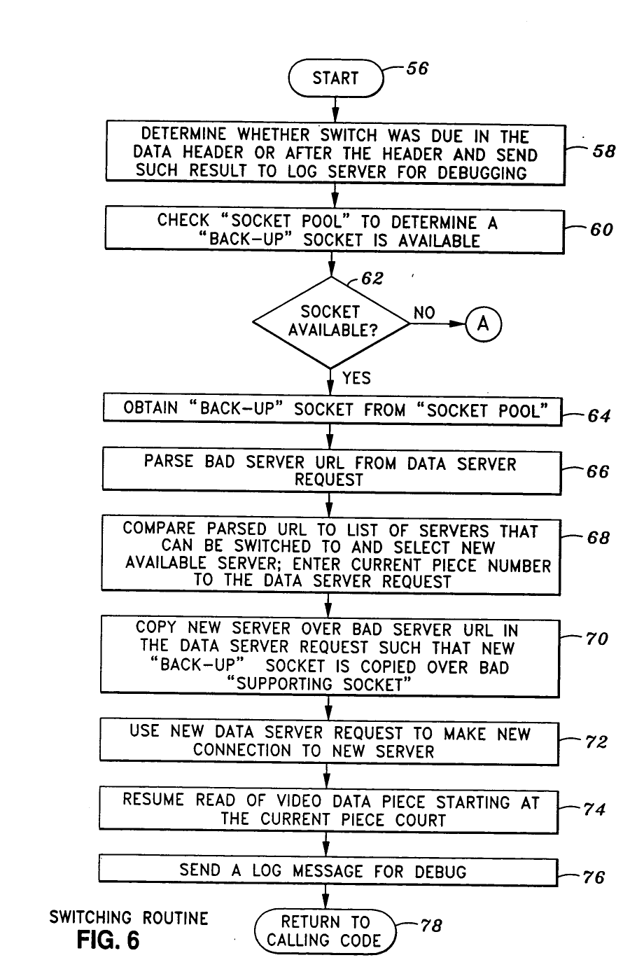

The present invention may utilize one or more sequences (e.g., computer code sequences) to implement the aforementioned method. In particular, the present invention, may utilize at least one of a Socket Generalization and Initialization sequence (see FIG. 4 and affiliated code listing in Appendix), Timing of Data Transfer sequence (see FIG. 5 and affiliated code listing in Appendix), and a Switching Routine (see FIG. 6 and affiliated code listing in Appendix). The exemplary following sequences are now individually described herein below.

Socket Generation and Initialization:

FIG. 4 is a flow chart depicting an exemplary Socket Generation and Initialization sequence, according to an aspect of the present invention. An exemplary computer code listing of the Socket Generation and Initialization sequence is also provided at the end of the specification. This sequence is at the start of the video transfer in the initialization phase. At step 20, the Socket Generation and Initialization sequence is initiated. At step 22, it is first determined whether the video had been initialized. If NO, then the sequence returns to the calling code at step 24. If YES, then the number of sockets required to expediently transmit the video data is determined (“supporting sockets”) at step 26. At step 28, the required “supporting sockets” plus extra “back-up” sockets are initiated. At step 30, a “socket pool” is created from the extra “back-up” sockets. Once the “socket pool” is created, the sequence terminates at step 32. It is noted that on the third line of the exemplary computer code listing, three times the needed sockets is utilized as a factor to determine the amount of extra “back-up” sockets. However, it is acknowledged that this factor is exemplary and may be higher or lower.

Timing of the Data Transfer:

FIG. 5 is a flow chart depicting an exemplary Timing and Data Transfer sequence, according to an aspect of the present invention. An exemplary computer code listing of the Timing and Data Transfer sequence is also provided at the end of the specification. This part of the code is for “reading in” the video data and operates as a loop that continues to read pieces from each connection until the entire video is read. At step 34, the Timing and Data sequence is initiated. After the sequence is initiated, a timer is read at step 36. In this regard, the second and third lines of the code show that the high precision timer of the video hardware is used to time each piece of video read. The timer is read at the start of the read (step 36) and at the end of the read (step 46). The difference in these times is the transfer time that is used to determine if switching is needed. At step 38, the video system begins reading video pieces from one of the plurality of “supporting sockets”. At step 40, the video system determines a read status of the video piece (i.e., “good/nominal performance or “error/problematic performance”). In this regard, the fifth line of the code is the actual read followed by a code to determine the read status (“good/nominal performance” or “error/problematic performance”). Since a socket read may not get the entire piece in a single read, the read may occur consecutively a few times to get an entire piece. Included in this code is a test to see if the read is complete. In particular, at step 42, a check is made to determine whether the entire video piece was read. If NO, the video system continues to read the same video at step 44. If YES, the timer is read again at step 46. At step 48, the difference between the start and end time is calculated. At step 50, a check is made to see if the read took less than one second (or any other acceptable period of time)? If NO, the Switching Routine is initiated at step 52 (see FIG. 6). If YES, the video system begins reading a video piece from the next one of the plurality of “supporting sockets” at step 54 so that the read loop is continued with the next connection.

The Switch:

FIG. 5 is a flow chart depicting an exemplary Timing and Data Transfer sequence, according to an aspect of the present invention. This routine performs the switching. At step 56, the sequence is initiated. At step 58, the video system determines whether the switch occurred in the data header or after the header. This is used to send a message to the log server for debugging. At step 60, a status check is performed on the “socket pool” to determine if a “back-up” socket is available. In this regard, the code is found twenty lines into the code a check is made to see if all pool sockets were used. If an initialized socket is not available (NO), the video system may return back to step 54, the Timing of Data Transfer sequence to begin reading video pieces from the next one of the plurality of “supporting sockets”. If YES, then at step 64, a “back-up” socket from the “socket pool” is obtained. Following step 64, the “bad” server URL is parsed from the data server request at step 66. This URL is used to compare to a list of available servers and to select a new acceptable nominally performing (or “good”) server which is different than the problematic (or “bad”) one at step 68. The current piece number is then entered to the data server request (the new starting place in the video) at step 68. Following this, the new nominally performing (or “good”) switching server URL is selected and copied over the problematic (or “bad”) server URL in the data server request at step 70. Now the new acceptable performing “good” socket (identified by a handle) is copied over the unacceptably performing “bad” socket. At this point the new data server request has been formed and is used to make a new connection to the new server at step 72. Then the read of video data resumes at the current piece count at step 74. At step 76 the routine sends a log message for debug. If an error occurred, a log message is sent for debugging. The calling code will detect the error and signal for a new switch in its next loop. At step 78, the routine returns to the calling code.

Although the invention has been described with reference to several exemplary embodiments, it is understood that the words that have been used are words of description and illustration, rather than words of limitation. Changes may be made within the subject matter of the appended claims, as presently stated and as amended, without departing from the scope and spirit of the invention in its aspects. Although the invention has been described with reference to particular embodiments, the invention is not intended to be limited to the particulars disclosed; rather, the invention extends to all functionally equivalent structures, methods, and such uses are within the scope of the appended claims.

In accordance with various embodiments of the present invention, the methods described herein are intended for operation as software programs running on computer processors, servers or the like which support the aforementioned video streaming systems. Dedicated hardware implementations including, but not limited to, application specific integrated circuits, programmable logic arrays and other hardware devices can likewise be constructed to implement the methods described herein. Furthermore, alternative software implementations including, but not limited to distributed processing, component/object distributed processing, parallel processing and virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or re-writable (volatile) memories. Accordingly, the invention is considered to include a tangible storage medium or distribution medium, as listed herein and an art-recognized equivalent and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, PPP, FTP) represent examples of the state of the art. Such standards are periodically superseded by faster or more efficient equivalents having essentially the same functions. Accordingly, replacement standards and protocols having the same functions are considered equivalents.

1. A method for switching video stream servers in a video streaming system adapted to transmit video data over the Internet comprising:
creating and initializing a plurality of supporting sockets for transmitting video data over the Internet;
creating a socket pool comprising a plurality of initialized back-up sockets;
reading at least one video piece from at least one of the plurality of supporting sockets;
determining whether the time period required for reading the at least one video piece is greater than a predetermined period of time; and
switching a supporting socket, for which the time period for reading at least one video piece was greater than the predetermined period of time, with back-up sockets from the socket pool.

2. The method according to claim 1, wherein creating and initializing the plurality of supporting sockets includes determining a number supporting of sockets required to effectively transmit video data for a desired application.

3. The method according to claim 2, wherein the number of back-up sockets to be created is determined by multiplying the determined number of supporting sockets by a predetermined factor.

4. The method according to claim 1, wherein the amount of time required for reading at least one video piece is determined by,
reading a timer at a start time before each video piece is read;
reading a timer at an end time after each video piece has been read; and
calculating the difference between the start and end time.

5. The method according to claim 4, wherein the switching further comprises of the determination of a read status for each video piece to verify that the entire video piece was read.

6. The method according to claim 1, further comprising determining whether the switching was due in the data header or after the header, and sending such result to a log server for debugging.

7. The method according to claim 1, further comprises of checking the socket pool to determine if an initialized back-up socket is available before switching a problematic supporting socket with a nominally performing back-up socket.

8. The method according to claim 1, wherein switching further comprises, parsing a problematic server URL from a data server request;
comparing the parsed URL to a list of nominally performing servers that can be switched thereto; and
entering a current piece number to the data server request.

9. The method according to claim 1, wherein switching further comprises of copying a nominally performing server URL over the problematic server URL in a data server request such that a nominally performing back-up socket is copied over a problematic supporting socket.

10. The method according to claim 9, wherein switching further comprises of using the data server request to make a new connection to a nominally performing server.

11. The method according to claim 10, wherein switching further comprises of sending a log message for debug.

12. The method according to claim 1, further comprising of resuming the reading of a video data piece starting at a current piece count.

13. A computer readable medium storing a computer program for switching video stream servers in a video streaming system adapted to transmit video data over the Internet comprising:
a source code segment for socket generation and initialization that,
creates and initializes a plurality of supporting sockets for transmitting video data over the Internet; and
creates a socket pool comprising of a plurality of initialized back-up sockets;
a source code segment for timing of data transfer that,
reads at least one video piece from at least one of the plurality of supporting sockets; and
determines whether the time period required for reading the at least one video piece is greater than a predetermined period of time;
a source code segment for switching servers that,
switches problematic supporting sockets, for which the time period for reading at least one video piece was greater than the predetermined period of time, with nominally performing back-up sockets from the socket pool.

14. The medium according to claim 13, wherein the source code segment for socket generation and initialization further determines the number of supporting sockets required to effectively transmit video data for a desired application.

15. The medium according to claim 14, wherein the source segment for the socket generation and initialization determines a number of back-up sockets to be created by multiplying the number of supporting sockets by a predetermined factor.

16. The medium according to claim 13, wherein the source code segment for timing of data transfer determines the amount of time required for reading at least one video piece by,
reading a timer at a start time before each video piece is read;
reading a timer at an end time after each video piece has been read; and
calculating the difference between the start and end.

17. The medium according to claim 16, wherein the source code segment for the timing of data transfer further determines a read status for each video piece to verify that the entire video piece was read.

18. The medium according to claim 13, wherein the source code segment for switching servers determines whether the switching occurred in the data header or after the header, and sends such result to a log server for debugging.

19. The medium according to claim 13, wherein the source code segment for switching servers checks the “socket pool” to determine if an initialized back-up is available before switching supporting sockets to a back-up socket.

20. The medium according to claim 13, wherein the source code segment for switching servers further,
parses a problematic server URL from a data server request;
compares the parsed URL to a list of nominally performing servers that can be switched thereto; and
enters a current piece member to the data server request.

21. The medium according to claim 20, wherein the source code segment for switching servers further copies a nominally performing server URL over the problematic server URL in a data server request such that a nominally performing back-up socket is copied over a problematic supporting socket.

22. The medium according to claim 21, wherein the source code segment for switching servers further uses the data server request to make a new connection to a nominally performing server.

23. The medium according to claim 21, wherein the source code segment for switching servers further sends a log message for debugging.

24. The medium according to claim 13, wherein the source code segment for switching servers further resumes reading a video data piece starting at the current piece count.

25. A video streaming system configured in distributed network architecture interfaced with the Internet, comprising a plurality of video servers, at least one user system, a logger server and system monitor, and a website server, the video streaming system further comprising:
a computer readable medium storing a computer program for switching video stream servers in a video streaming system for transmitting video over the Internet comprising:
a source code segment for socket generation and initialization that,
creates and initializes a plurality of supporting sockets for transmitting video data over the Internet; and
creates a socket pool comprising a plurality of initialized back-up sockets;
a source code segment for timing of data transfer that,
reads at least one video piece from at least one of the plurality of supporting sockets; and
determines whether the time period required for reading at least one video piece is greater than a predetermined period of time; and
a source code segment for switching servers that,
switches problematic supporting sockets, for which the time period for reading at least one video piece is greater than the predetermined period of time, with nominally performing back-up sockets from the socket pool.

26. The system according to claim 25, wherein the source code segment for socket generation and initialization further determines the number of supporting required to effectively transmit video data for a desired application.

27. The system according to claim 26, wherein the source segment for socket generation and initialization determines a number of back-up sockets to be created by multiplying the number of supporting sockets by a predetermined factor.

28. The system according to claim 25, wherein the source code segment for the timing of data transfer determines the amount of time required for reading the at least one video piece by,
reading a timer at a start time before each video piece is read;
reading a timer at an end time after each video piece has been read; and
calculating the difference between the start and end.

29. The system according to claim 28, wherein the source code segment for timing of data transfer further determines a read status for each video piece to verify that the entire video piece was read.

30. The system according to claim 25, wherein the source code segment for switching servers determines whether the switching was due in a data header or after the header, and sends such result to a log server for debugging.

31. The system according to claim 25, wherein the source code segment for switching servers checks the socket pool to determine if an initialized back-up is available before switching supporting sockets with a back-up socket.

32. The system according to claim 25, wherein the source code segment for switching servers further,
parses a problematic server URL from a data server request;
compares the parsed URL to a list of nominally performing servers that can be switched thereto; and
enters a current piece member to the data server request.

33. The system according to claim 32, wherein the source code segment for switching servers further includes copying a nominally performing server URL over the problematic server URL in a data server request such that a nominally performing back-up socket is copied over a problematic supporting socket.

34. The system according to claim 33, wherein the source code segment for switching servers further uses the data server request to make a new connection to a nominally performing server.

35. The system according to claim 34, wherein the source code segment for switching servers further sends a log message for debugging.

36. The system according to claim 25, wherein the source code segment for switching servers further resumes reading a video data piece starting at the current piece count.
